(19) United States
(12) Patent Application Publication
(10) Pub. No.: US 2008/0199073 A1
(43) Pub. Date: Aug. 21, 2008

(54) Red eye detection in digital images

(75) Inventor: Denis Demandolx, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/708,295

(22) Filed: Feb. 20, 2007

(51) Int. Cl. G06K 9/00

(52) U.S. Cl. 382/167

(57) ABSTRACT

A red-eye detection methodology is provided in which a likelihood of red-eye is estimated on a pixel by pixel basis for at least a portion of a digital image. Pixels that most likely belong to a red-eye area are identified by applying a red-eye probability model that is built from the statistical analysis of a relatively large set of image samples for which red-eye areas have been subjective segregated from non-red-eye areas. By performing some regular statistical analysis of the segregation results, an estimate for red-eye probability for every pixel in the portion of the image of interest may be generated based solely on the RGB (Red, Green, Blue) values of the pixel.

### BACKGROUND

Red-eye is a problem that is commonly encountered in photography when light—typically from the camera's flash—reflects off the retinas at the back of the subject's eyes and causes the eyes to appear red. Red-eye has been a problem for many years, and although a variety of solutions have been proposed to cure the problem, these solutions are not always satisfactory.

One solution is to use a bounce flash—or to configure the camera in such a manner as to position the flash at a distance from the lens—so that light hits the subject's eyes from the side, or from above or below rather than straight-on, to thus prevent the reflected light from coming straight back to the camera's lens. However, such flash arrangements can be large and cumbersome, or are often not a realistic option to be used, particularly with compact consumer-oriented digital cameras. Another solution is to pre-flash the subject to cause the subject's pupils to close and decrease the amount of light allowed into the subject's eyes when the picture is taken. Such pre-flash solutions, however, are not effective in all settings, and may cause a delay while the pre-flash is operating (i.e., before the picture is actually taken) during which time the subject may move or otherwise affect the composition of the shot. In addition, some people instinctively close their eyes when subjected to the pre-flash which increases the probability that the captured image will be unsatisfactory.

Other solutions address the red-eye problem by post-processing the image captured by the camera to remove the red from the eyes. Computer software tools are available that allow for the removal of red-eye, such as by changing the color of the red portion of the eye. While such solutions are satisfactory in some applications, some software tools do not reliably and accurately detect red-eye in all images in all settings.

This Background is provided to introduce a brief context for the Summary and Detailed Description that follows. This Background is not intended to be an aid in determining the scope of the claimed subject matter nor be viewed as limiting the claimed subject matter to implementations that solve any or all of the disadvantages or problems presented above.

### SUMMARY

A red-eye detection methodology is provided in which a likelihood of red-eye is estimated on a pixel by pixel basis for at least a portion of a digital image. Pixels that most likely belong to a red-eye area are identified by the application of a red-eye probability model that is built from the statistical analysis of a relatively large set of image samples for which red-eye areas have been subjectively segregated from non-red-eye areas. By performing some regular statistical analysis of the segregation results, an estimate for red-eye probability for every pixel in the portion of the image of interest may be generated based solely on values of the pixel in the RGB (Red, Green, Blue) color model.

In an illustrative example, the detection methodology is utilized to segment red-eye pixels from non-red-eye pixels in a digital image. A redness estimation function is applied to the red-eye pixel candidates identified through application of the red-eye probability model noted above to create a redness histogram. Regular histogram thresholding segmentation is then applied, combined with a region growing segmentation method. The resulting red-eye segmentation mask is subjected to a mathematical morphology closing operation to filter out small holes in the segmentation mask. The segmentation mask is smoothed through application of low pass filtering. The resulting segmented area is then able to be corrected using one of several red-eye correction methodologies to thereby remove/correct the red-eye from the image.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative environment in which the present arrangement for red-eye detection may be performed;

FIG. 2 is a diagram that illustrates how the red-eye effect is produced through interaction between a camera flash and the blood vessels inside an eye;

FIG. 3 shows an illustrative user interface operating on a computer system for selecting an image portion that contains red-eye;

FIG. 4 is a detailed view of an illustrative image showing red-eye;

FIG. 5 is a detailed view of the illustrative image shown in FIG. 4 after red-eye correction;

FIGS. 6 and 7 show a flowchart for an illustrative method for detecting red-eye;

FIG. 8 is an illustrative two-dimensional scatterplot projection of a three-dimensional RGB parameter space in which g′ is plotted against R, where g′=G/(R+G+B), for subjectively identified non-red-eye pixels; and

FIG. 9 is an illustrative two-dimensional scatterplot projection of a three-dimensional RGB parameter space in which g′ is plotted against R for subjectively identified red-eye pixels.

Like reference numerals indicate like elements in the figures.

### DETAILED DESCRIPTION

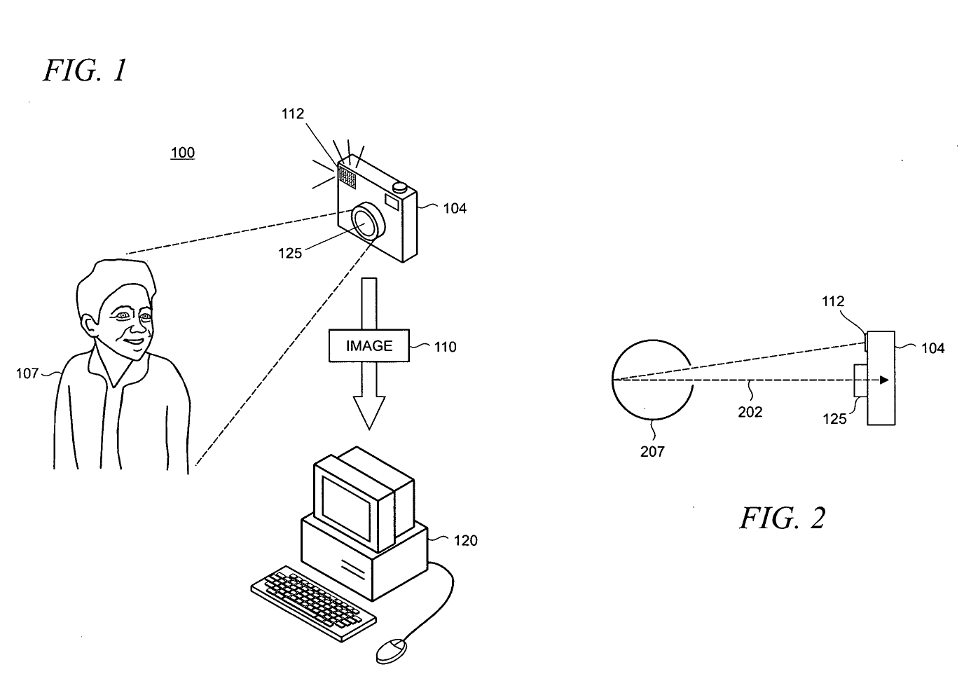

FIG. 1 shows an illustrative environment 100 in which the present arrangement for red-eye detection may be performed. A camera 104 is used to take one or more images 110 of the subject 107 using a flash 112 that may potentially cause red-eye in the captured images. The images 110 are analyzed for red-eye using the present detection methodology as described in more detail below. Such red-eye detection is typically performed on the images 110 after they are transferred to a computer system 120, such as a personal or laptop computer. Other devices may also be arranged to perform red-eye detection using the present methodology, for example, printers, scanners, and other image storage and viewing devices. In addition, the present red-eye detection methodology is alternatively performed by the camera 104 itself.

Camera 104 may be arranged from any type of image capture device that captures and stores, or communicates images, such as a film camera, a digital camera, a video camera, a camcorder, etc. Camera 104 typically captures images using any of a variety of conventional methods, such as exposing film on which the images are captured, exposing one or more charge coupled devices (“CCDs”), and storing a captured still or motion image in memory (e.g., a removable solid-state memory such as a flash memory, hard disk, or other magnetic or optical storage medium). In many consumer-type cameras, the flash 112 is disposed within the camera body in such a way as to be relatively close to the camera lens 125.

Such proximity of the flash to the camera lens tends to exacerbate the occurrence of red-eye in pictures taken by typical users. As shown in FIG. 2, light (indicated by reference numeral 202) from the flash 112 is reflected from the subject's eye 207 with an acute angle so that it travels directly into the camera lens 125. The light is focused onto the blood-rich retina at the back of the eye and the image of the illuminated retina is transmitted to the camera resulting in the red appearance of the eye on the captured image. In addition, red-eye may still occur even if the line of sight of the camera is not orthogonal to the plane of the retina. Here, a reflecting structure behind the retina forms a spherical concave mirror so that the eye behaves as a “catseye” reflector (i.e., a retroreflector) to reflect the light from the flash back through the camera lens to thereby cause the red-eye effect in the captured image.

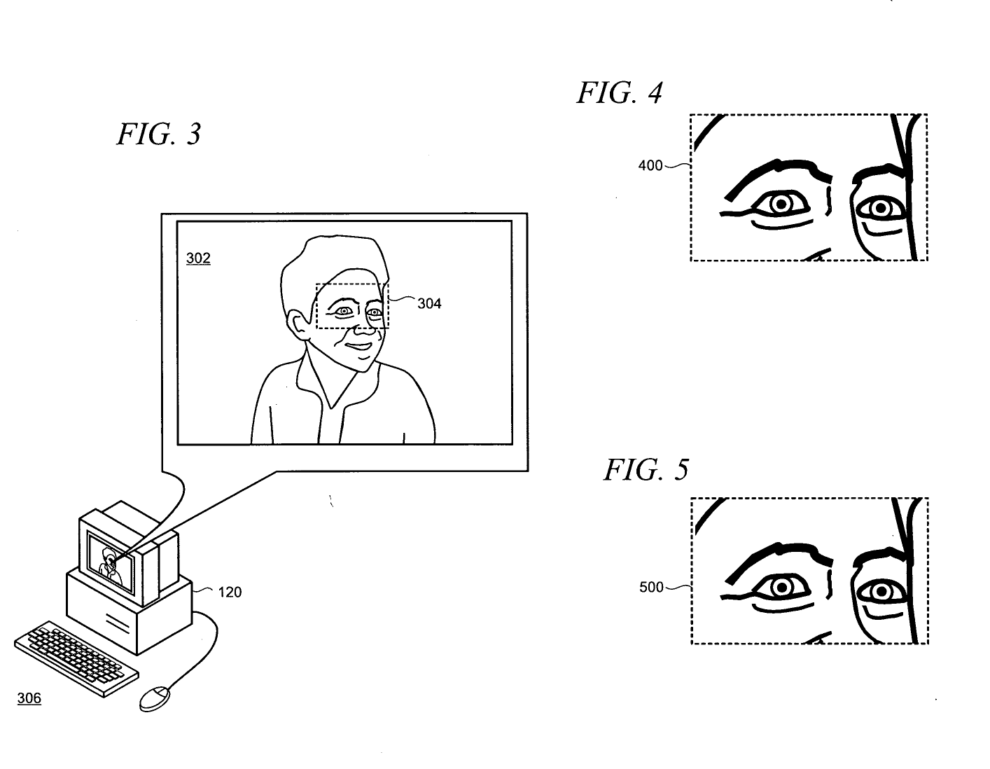

In most applications, images 110 are transferred from camera 104 to computer system 120 in a digital format. Alternatively, conventional photographs may be utilized after being digitized using, for example, an optical scanner or other digitizing device. As shown in FIG. 3, an image that is sought to be corrected for red-eye is displayed by the computer system 120 using a graphical user interface 302 (“GUI”). The GUI is typically arranged to enable a user to select a portion of the image of interest that contains a red-eye area as indicated by the selection window 304. Such selection is facilitated through interaction with input devices such as a keyboard or mouse (collectively identified by reference numeral 306). However, it is emphasized that present red-eye detection methodology may be applied on an entire image basis. FIGS. 4 and 5 show detailed views of a user-selected portion of the subject 107 shown in FIG. 1 both before and after, respectively, the application of the present red-eye detection methodology and correction of the red-eye. In FIG. 4, selection window 400 shows the image prior to application of red-eye detection and correction. In FIG. 5, selection window 500 shows the image after application of red-eye detection and correction.

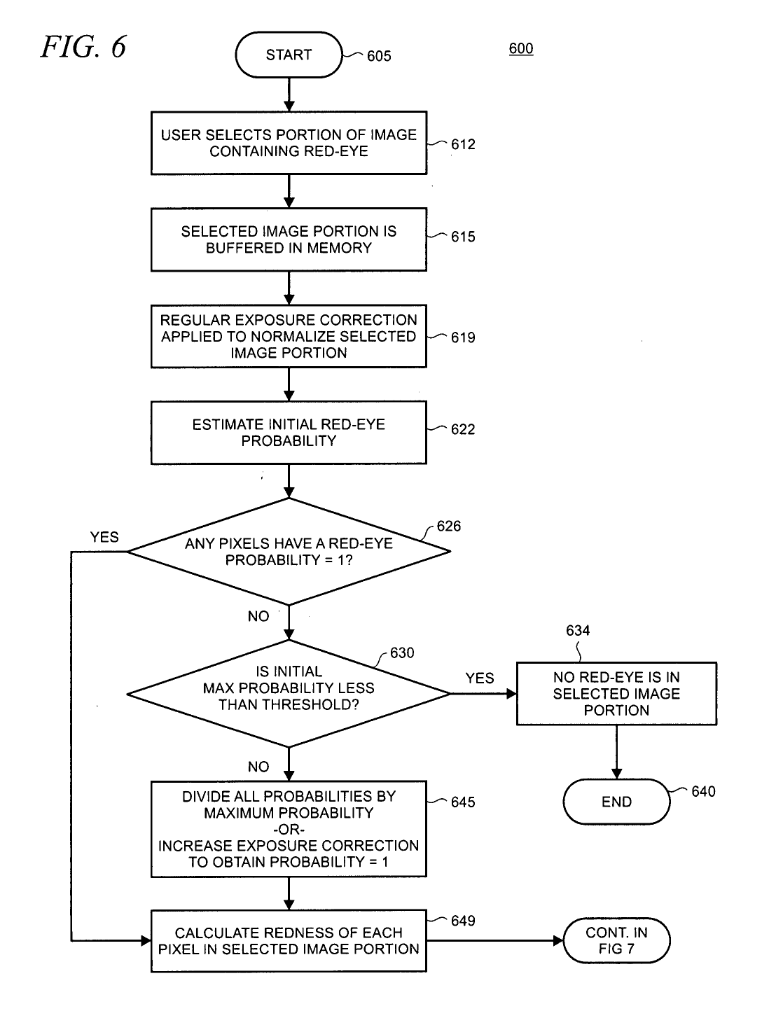

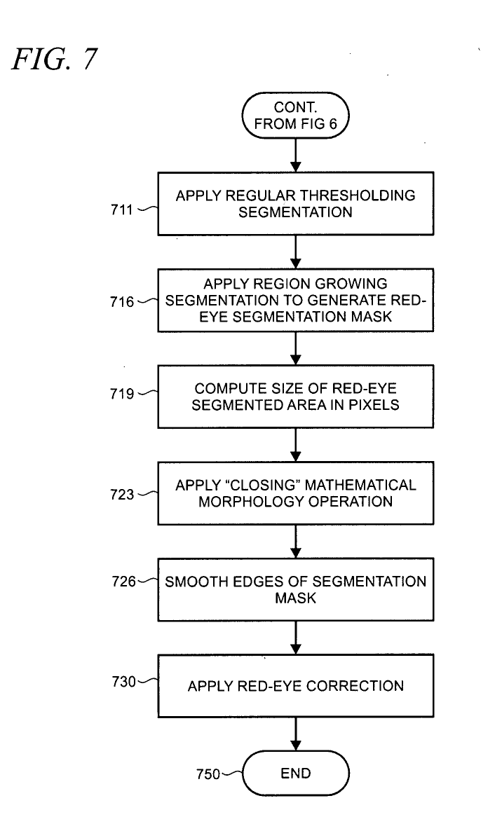

FIGS. 6 and 7 show a flowchart for an illustrative method 600 for detecting red-eye using the present probability-based red-eye detection methodology. As noted above the red-eye detection methodology is typically performed by a device such as a personal computer, printer, or camera. The method starts at block 603. At block 612, a user selects a portion of an image of interest (hereinafter called the “target image”) for which red-eye detection and correction is desired. As noted above, this user selection feature does not necessarily need to be enabled in every application of the present red-eye detection methodology. The selected image portion is buffered in memory, as indicated by block 615.

Block 619 indicates an optional step in the method 600. In this optional step, some regular exposure correction is applied to the selected image portion. Each pixel value using the RGB color model is multiplied by a constant value so that the maximum pixel value is actually the maximum pixel value possible. This provides a normalization of the image in cases where the image is obviously underexposed. Such exposure correction is generally performed to enhance the accuracy of the red-eye detection methodology on images that are initially too dark.

An estimation is made of an initial red-eye probability on a pixel by pixel basis, as indicated by block 622. This is achieved by the utilization of a probability model that is generated through subjective analysis of a large number of sample images to segregate red-eye areas from non-red-eye areas. More particularly, a human analyst, on an image by image basis, surveys the sample images to identify pixels on a subjective basis that that belong to the red-eye area or not. The RGB values for the identified pixels are stored in a three-dimensional RGB parameter space. Using regular statistical classification methods that are known, for example the k-nearest-neighbor method, an a-priori red-eye likelihood of every point in the RGB color cube is inferred. Accordingly, the present red-eye detection methodology enables estimation of a red-eye probability for each pixel based solely on the RGB values of that pixel.

The present red-eye detection methodology generally provides more reliable and accurate results as the number of sample images used for the subjective survey increases. In particular, empirical data has shown that superior red-eye detection is achieved for most consumer-oriented applications when the number of sample images surveyed numbers in the hundreds. However, it is envisioned that more or fewer sample Images can be surveyed and provide satisfactory results in other applications.

At decision block 626 a determination is made as to whether any pixels have a red-eye probability equal to 1 using the subjective probability red-eye model described above. If no pixels have a red-eye probability of 1, then control passes to decision block 630. If one or more pixels have a red-eye probability of 1, then control passes to block 649.

If an initial maximum probability (as estimated by the step shown at block 622) is less than a predetermined threshold, then a determination is made that no red-eye exists in the selected portion of the target image, as indicated at block 634. Method 600 then ends at block 640.

If at decision block 630 the initial maximum probability exceeds the threshold, and red-eye is said to exist, then one of two alternative steps is performed at block 645. The first alternative comprises dividing all of the initial red-eye probabilities by the value of the maximum red-eye probability. The second alternative comprises increasing the regular exposure correction noted at block 619 until a red-eye probability of 1 is obtained for one or more pixels.

At block 649 the redness of each pixel in the selected portion of the target image (but excluding pixels that are not likely candidates for red-eye, i.e., those that have low or zero probability of red-eye) is calculated using the formula:

Redness=R/(R+G+B) (1)

Other redness calculation formulas or estimation functions may also be used depending on the requirements of a specific application of red-eye detection. However, application of formula (1) above has shown to provide superior results. The resulting redness values are populated into a redness histogram.

Method 600 continues on FIG. 7 where, at block 711, regular thresholding segmentation is applied to the redness histogram to determine a threshold value, below which, pixels are said to have low redness and above which, pixels are said to have high redness. Thresholding is a well understood technique and is described, for example, by Otsu, N., A Threshold Selection Method for Grey Level Histograms, IEEE Transactions on Systems, Man, and Cybernetics 9, 62-66. (1979)

At block 716, region growing segmentation is applied starting with the pixel, or pixels, that have a red-eye probability equal to 1. That is, all pixels that have a red-eye probability equal to 1 are labeled as red-eye van, other pixels are labeled as red-eye using an iterative process when such pixels meet all of the following criteria: A) the candidate pixel has a pixel neighbor that is already labeled as a red-eye pixel, and B) the redness of the candidate pixel is a greater or equal to the threshold calculated at block 711, and C) the local redness distribution around the candidate pixel is convex. In this latter case, convexity is determined in two dimensions of the 3×3 matrix of color model values. The direction that is most aligned between the center of the red-eye (estimated as the center of gravity of pixels that have a red-eye probability equal to 1) and the candidate pixel is selected to thereby test the local redness distribution, i.e., whether a 3-pixel subset is convex or concave.

The result of the region growing segmentation is a red-eye segmentation mask. At block 719, the size of the red-eye segmented area is calculated in pixels. The average radius is given by:

Radius=\sqrt{area/π} (2)

At block 723, a mathematical morphology operation called “closing” is applied using a radius proportional to the radius provided by formula (2) above. Morphology is well described by Serra, J., Introduction to Mathematical Morphology, Computer Vision, Graphics and Image Processing 35, 283 (1986). The closing operation is utilized to filter out small holes in the segmentation mask.

At block 726 the edges of the segmentation mask are smoothed proportionally to the radius calculated using formula (2) through application of a regular low pass filter on the segmentation mask. This step is utilized simply to smooth the segmentation mask and avoid sharp transitions between corrected and uncorrected red-eye areas that may be noticeable.

The segmentation mask is used to determine how much correction should be applied. Areas of the image are outside the red-eye area if the mask value is 0 and no correction is applied. If the mask value is 1, then full correction is applied to remove all of the redness. If the mask value is between 0 and 1, then:

Corrected image=((1−mask)×original image)+(mask×corrected image) (3)

At block 730, a red-eye correction is applied. Any one of a variety of conventional red-eye correction techniques may be applied at this step including, for example, pixel color de-saturation, pixel value modification, pixel blending, or pixel replacement.

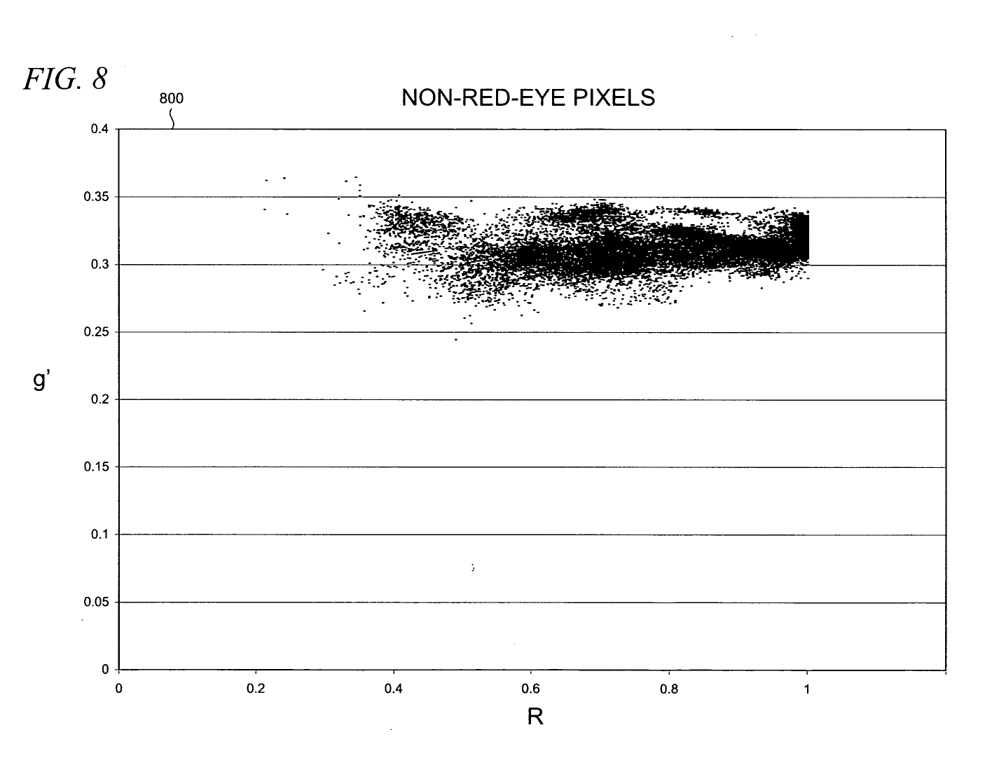

FIG. 8 is an illustrative two-dimensional scatterplot projection 800 of a three-dimensional RGB parameter space in which g′ is plotted against R for non-red-eye pixels that were subjectively identified from the set of image samples as described above, where:

g′=G/(R+G+B) (4)

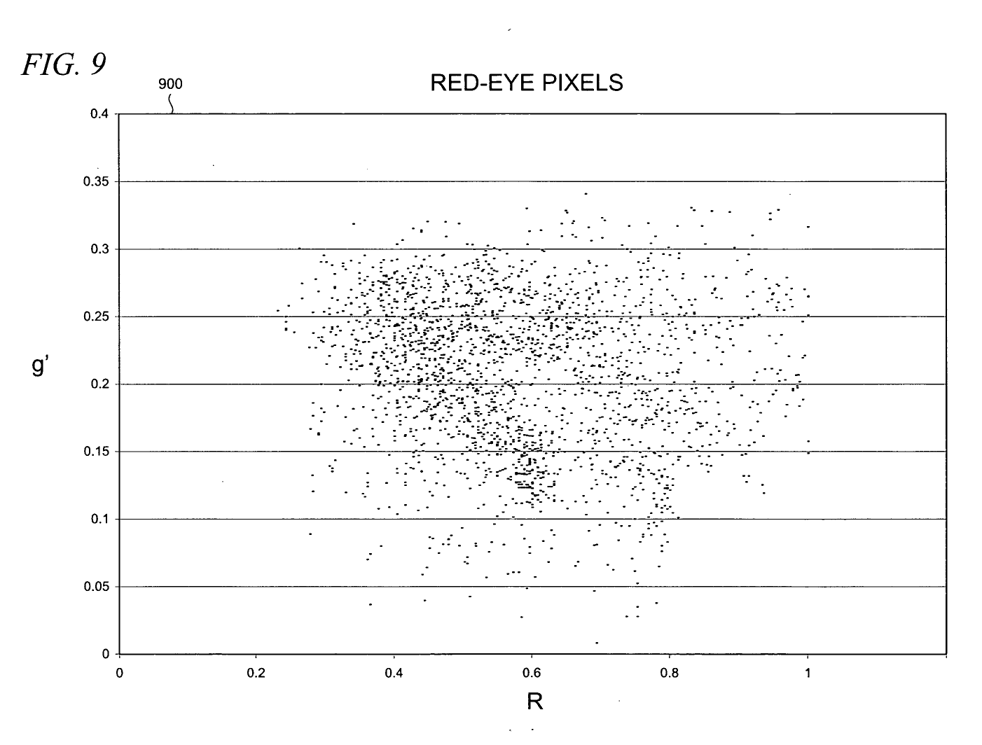

FIG. 9 is an illustrative two-dimensional scatterplot projection 900 of a three-dimensional RGB parameter space in which g′ is plotted against R for subjectively identified red-eye pixels.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is c;aimed is:

1. A method for detecting red-eye in an image, the method comprising the steps of:
performing a pixel-by-pixel analysis of each pixel in the image, the analysis being based on values of a pixel in an RGB color space;
statistically analyzing the pixel in the image to estimate a red-eye probability for the pixel; and
if no pixel in the image is estimated to have a red eye probability of 1, then either a) dividing all red-eye probabilities for pixels in the image by a maximum estimated red-eye probability, or b) increasing an exposure level of the image until an estimated red-eye probability of 1 for one or more pixels is achieved.

2. The method of claim 1 in which the estimating uses a red-eye probability model that is generated using a subjective determination of red-eye for each of a plurality of images in a sample set of images.

3. The method of claim 2 including a further step of calculating a redness for each pixel in the selected portion using the formula, Redness=R/(R+G+B) to create a redness histogram for the selected portion.

4. The method of claim 3 including a further step of applying regular thresholding segmentation of the redness histogram to determine a threshold value, below which pixels are defined as having a low redness and above which pixels are defined as having a high redness.

5. The method of claim 4 including a further step of applying a region growing segmentation to a pixel having a highest red-eye probability and iteratively labeling a pixel of interest as a red-eye pixel if the pixel of interest is a) neighboring pixel to the pixel having highest red-eye probability and b) has a redness equal to or exceeding the threshold value and c) a local redness distribution associated with the pixel of interest is convex, to thereby generate a red-eye segmentation mask.

6. The method of claim 5 including a further step of computing a size of a red-eye segmented area in pixels where a radius of the segmented area=square root (red-eye segmented area/π).

7. The method of claim 6 including a further step of applying a mathematical morphology closing operation in which a closing radius is proportional to the radius of the segmented area.

8. The method of claim 7 including a further step of smoothing edges of the red-eye segmentation mask by applying a regular low-pass filter.

9. The method of claim 8 in which the smoothing is proportional to red-eye image size.

10. The method of claim 5 in which convexity of the local redness distribution is determined in two dimensions in a 3×3 matrix of RGB values in a direction that is aligned between the pixel of interest and a red-eye center.

11. The method of claim 1 including a further step of applying exposure correction to the image in which each pixel value is multiplied by a constant value so as to normalize an exposure of the image.

12. A computer-readable medium containing instructions which, when executed by one or more processors disposed in an electronic device, performs a method for correcting red-eye in a digital image, the method comprising the steps of:
invoking a method for providing an interface to a user for selecting a portion of the digital image to be corrected for red-eye;
applying regular statistical analysis to each of the pixels in the selected portion in an RGB color space to identify one or more pixels that have an estimated red-eye probability of 1 using a probability model created through subjective identification of red-eye in a plurality of sample images; and
correcting the identified one or more pixels in the selected portion of the digital image.

13. The computer-readable medium of claim 12 in which the correcting is selected from one of pixel color de-saturation, pixel value modification, pixel blending, or pixel replacement.

14. The computer-readable medium of claim 13 in which the correcting comprises inserting a color that is substantially black into an area of the image associated with the identified one or more pixels.

15. The computer-readable medium of claim 12 in which the identifying is performed using solely RGB values of the one or more pixels.

16. A method for generating a red-eye probability model used for detecting red-eye in a target image, the method comprising the steps of:
generating a database of sample images, each sample image in the database having an image portion containing red-eye;
subjecting each sample image in the database to subjective analysis to identify RGB values for the image portion containing red-eye; and
generating the red-eye probability model using the RGB values from the image portion containing red-eye in the sample images in the database, the red-eye probability model being usable to estimate a probability that one or more pixels in the target image is a red-eye pixel.

17. The method of claim 16 including a further step of incorporating the red-eye probability model into a red-eye detection and correction software application program, module, or utility.

18. The method of claim 17 in which the red-eye detection and correction module is incorporated as a portion of a feature set provided by a computer operating system.

19. The method of claim 16 in which the subjective analysis comprises inspection by a human being of a plurality of images to segregate red-eye portions from non-red-eye portions in each image within the plurality of images.

20. The method of claim 16 in which the database of sample images includes at least 100 images.
